(19) United States
(12) Patent Application Publication
(10) Pub. No.: US 2005/0138560 A1
(43) Pub. Date: Jun. 23, 2005

(54) Method and apparatus for broadcasting live personal performances over the internet

(76) Inventors: Kuo-Chun Lee, Fremont, CA (US); Ke-Qin Gu, Milpitas, CA (US); Tsung-Yen (Eric) Chen, Fremont, CA (US); Victor H. Okumoto, Fremont, CA (US)

Correspondence Address: VICTOR H. OKUMOTO, P.O. BOX 6120, FREMONT, CA, 94538, US

(21) Appl. No.: 10/740,067

(22) Filed: Dec. 18, 2003

(51) Int. Cl. H04N 7/173; G11B 27/00

(52) U.S. Cl. 715/719; 725/109; 725/110; 709/217; 709/219; 715/513; 715/500.1; 715/747; 715/758; 725/37; 725/51

(57) ABSTRACT

A method and apparatus for broadcasting live personal performances over the Internet employs a web server to manage scheduling and broadcasting of the performances over the Internet, as well as collections and payments for products and services sold by presenters to viewers in conjunction with their performances. The server receives audio/video data from presenter operated computers through an uploaded presenter program, and relays the received audio/video data to viewer operated computers for viewing in media players invoked by their web browsers responding to an uploaded HTML document or JAVA applet. Viewers select performances to view from a program schedule provided on a webpage hosted by the web server. Both viewers and presenters are registered with the web server to facilitate payments for products and services, and their financial information stored in a secure user database.

### FIELD OF THE INVENTION

The present invention generally relates to broadcasting communications over the Internet and in particular, to a method and apparatus for broadcasting live personal performances over the Internet.

### BACKGROUND OF THE INVENTION

Radio and television have long been the primary mediums for broadcasting communications to the general public. Both mediums, however, have been traditionally limited in the number of channels available for broadcasting over the air, because of limitations in respective broadcasting frequency ranges. Also, both mediums have traditionally required expensive equipment in broadcasting stations with large antennas, thereby effectively resulting in further limiting the number of channels commercially practical to operate in any one region.

Cable and satellite television systems have significantly increased the number of available channels for broadcasting communications. Although the cost of setting up and operating a broadcasting station is perhaps relatively less expensive than the past, such costs are still very substantial. Also, although more channels are available through cable and satellite, they are still limited by the number of channels that service providers are willing to offer to their customers.

The Internet does not have, or at least substantially reduces, these technical and cost limitations. Some commercial radio stations are already broadcasting their programs over the Internet, as well as their traditional broadcasting over the airwaves, to reach a larger and geographically dispersed audience. Some enterprising Internet portal companies provide program schedules for such broadcasting, and charge their users on a pay-per-view or subscription basis in order to receive these commercial radio broadcasts.

Individuals desiring to present their own personal performances over the Internet, however, do not have a low cost and readily available means of doing so today. Although such individuals could set up their own websites to present such performances, the costs and technical difficulty of doing so are not trivial.

Also, it may be difficult to attract prospective viewers to a website without expending substantial advertising dollars. Although commercially available search engines may be used to do so, they are still relatively crude and therefore, provide much less than exactly desired results. In addition, viewers may be reluctant to purchase products or services from an individual presenter that they do not know and/or whose product or service quality is also unknown.

As an example, musicians and other entertainers such as singers, actors, and comedians, may desire to perform over the Internet with the hope of being discovered, or make money from their talents by selling their performances (e.g., as a service) to viewers on a pay-per-view basis and/or selling recorded versions of their performances (e.g., as a product) on a pay-to-download basis. Viewers, on the other hand, may enjoy discovering new talent, and telling all their friends about their discovery.

As another example, consultants and other personal service providers such as tutors and fortune tellers, may also desire to perform their services over the Internet to reach a geographically dispersed audience without the need of either the service provider or his or her client to leave the convenience of their homes or offices.

Although the Internet may be the ideal medium for these and other individuals to broadcast their live personal performances to a broad audience, a simple infrastructure that allows them to do so in a low cost, easy to use, and technically simple manner is currently unavailable.

### OBJECTS AND SUMMARY OF THE INVENTION

Accordingly, it is an object of the present invention to provide a method and apparatus for broadcasting live personal performances over the Internet.

Another object is to provide such a method and apparatus so as to facilitate reliable, safe and low-risk purchasing of goods and/or services over the Internet by viewers of live personal performances from the presenters of such live personal performances.

Yet another object is to provide such a method and apparatus so as to facilitate an easy interface for presenters of such live personal performances to broadcast their performances over the Internet, and interact with and receive immediate feedback from their viewers if desired.

Still another object is to provide such a method and apparatus so as to facilitate an easy interface for prospective viewers of such live personal performances to find performances for their selection that are interesting and/or useful to them.

These and additional objects are accomplished by the various aspects of the present invention, wherein briefly stated, one aspect of the invention is a method for broadcasting live personal performances over the Internet, comprising: displaying a program schedule on a webpage of a website such that the program schedule includes a hyperlink to a broadcast of a live personal performance to be performed at a scheduled time over the Internet; receiving audio and video data over the Internet for the live personal performance from a computer operated by a presenter logged on to the website and performing the live personal performance at approximately the scheduled time; and broadcasting the received audio and the received video data to one or more computers respectively operated by viewers logged on to the website and having indicated a desire to receive such broadcast by clicking on the hyperlink.

Another aspect is an apparatus for broadcasting live personal performances over the Internet, comprising a server configured to: display a program schedule on a webpage of a website such that the program schedule includes a hyperlink to a broadcast of a live personal performance to be performed at a scheduled time over the Internet; receive audio and video data for the live personal performance over the Internet from a computer operated by a presenter logged on to the website and performing the live personal performance at approximately the scheduled time; and broadcast the received audio and the received video data to one or more computers respectively operated by viewers logged on to the website and indicating a desire to receive such broadcast by clicking on the hyperlink.

Another aspect is a method for broadcasting live personal performances over the Internet, comprising: receiving audio/video data over the Internet of personal performances respectively from presenter operated computers according to a program schedule provided on a webpage; and relaying individual of the received audio/video data over the Internet to one or more viewer operated computers as respectively requested by actions indicated through the webpage.

Another aspect is an apparatus for broadcasting live personal performances over the Internet, comprising a server configured to: receive audio/video data over the Internet of live personal performances respectively from presenter operated computers according to a program schedule provided on a webpage hosted by the computer; and relay individual of the received audio/video data over the Internet to one or more viewer operated computers as respectively requested by actions indicated through the webpage.

Another aspect is a system for broadcasting live personal performances over the Internet, comprising: a plurality of presenter operated computers; a plurality of viewer operated computers; and a web server hosting a webpage providing a program schedule, receiving audio and video data over the Internet of live personal performances respectively from the plurality of presenter operated computers at times according to the program schedule, and broadcasting individual of the received audio and video data over the Internet respectively to individual of the plurality of viewer operated computers as requested by actions indicated by their respective users through the webpage.

Another aspect is a method for broadcasting audio/video data over the Internet, comprising: generating a program schedule organized by categories and broadcast times from information received over the Internet from a plurality of presenter operated computers; providing the program schedule on a webpage; receiving audio/video data over the Internet from the plurality of presenter operated computers; and broadcasting at their respective broadcast times over the Internet, individual of the received audio/video data to one or more viewer operated computers as requested by their users over the Internet through the webpage.

Another aspect is an apparatus for broadcasting audio/video data over the Internet, comprising a web server configured to: generate a program schedule organized by categories and broadcast times from information received over the Internet from a plurality of presenter operated computers; provide the program schedule on a webpage; receive audio/video data over the Internet from the plurality of presenter operated computers; and broadcast at their respective broadcast times over the Internet, individual of the received audio/video data to one or more viewer operated computers as requested by their users over the Internet through the webpage.

Another aspect is a method for transmitting audio/video data over the Internet, comprising: transmitting a presenter program over the Internet to a presenter operated computer; receiving audio/video data over the Internet from the presenter program running on the presenter operated computer; and transmitting an HTML document and the received audio/video data to a viewer operated computer so that a web browser plays the received audio/video data in a window of a display screen of the viewer operated computer according to instructions in the HTML document.

Another aspect is an apparatus for transmitting audio/video data over the Internet, comprising a web server configured to: transmit a presenter program over the Internet to a presenter operated computer; receive audio/video data over the Internet from the presenter program running on the presenter operated computer; and transmit an HTML document and the received audio/video data to a viewer operated computer so that a web browser plays the received audio/video data in a window of a display screen of the viewer operated computer according to instructions in the HTML document.

Another aspect is a business method for broadcasting live personal performances over the Internet, comprising: registering an attendee after receiving contact and payment method information from the attendee over the Internet; providing a program schedule of live personal performances selectable for viewing over the Internet by the attendee; charging the attendee according to the payment method information for goods and services purchased over the Internet in conjunction with a live personal performance selected for viewing by the attendee from the program schedule; and paying a presenter of the live performance for the purchased goods and services less a service charge and expenses unless the attendee contests such paying within a period of time.

Yet another aspect is an apparatus for billing an attendee for goods and services purchased in conjunction with a live personal performance viewed over the Internet by the attendee, and pay the presenter of that live personal performance for those goods and services purchased by the attendee, comprising a computer configured to: register an attendee after receiving contact and payment method information from the attendee over the Internet; provide a program schedule of live personal performances selectable for viewing over the Internet by the attendee; charge the attendee according to the payment method information for goods and services purchased over the Internet in conjunction with a live personal performance selected for viewing by the attendee; and pay a presenter of the live performance for the goods and services less a service charge and expenses unless the attendee contests such payment within a period of time.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 illustrates a network diagram of a system for broadcasting live personal performances over the Internet, utilizing aspects of the present invention.

FIG. 2 illustrates a block diagram of software on a web server for broadcasting live personal performances over the Internet, utilizing aspects of the present invention.

FIG. 3 illustrates a top-level general webpage hosted by the web server for broadcasting live personal performances over the Internet, utilizing aspects of the present invention.

FIG. 4 illustrates additional details of a session categories area of the top-level general webpage hosted by the web server for broadcasting live personal performances over the Internet, utilizing aspects of the present invention.

FIG. 5 illustrates a second-level general webpage providing a program schedule for a music category hyperlinked from the session categories area of the top-level general webpage hosted by the web server for broadcasting live personal performances over the Internet, utilizing aspects of the present invention.

FIG. 6 illustrates a viewer display screen displayed on a monitor of a viewer operated computer by a web browser responding to an HTML document downloaded from the web server for broadcasting live personal performances over the Internet, utilizing aspects of the present invention.

FIG. 7 illustrates a second-level general webpage providing a listing of fortune tellers in a fortune tellers category hyperlinked from the session categories area of the top-level general webpage hosted by the web server for broadcasting live personal performances over the Internet, utilizing aspects of the present invention.

FIG. 8 illustrates a third-level general webpage providing a reservation schedule for a fortune teller hyperlinked from the second-level general webpage providing the listing of fortune tellers, utilizing aspects of the present invention.

FIG. 9 illustrates a presenter display screen displayed on a monitor of a presenter operated computer by a presenter program downloaded from the web server for broadcasting live personal performances over the Internet, utilizing aspects of the present invention.

FIG. 10 illustrates an alternative viewer display screen displayed on a monitor of a viewer operated computer during a sponsor program, utilizing aspects of the present invention.

FIGS. 11-12 illustrate a flow diagram of a method for registering and setting up a presenter of a live personal performance to be broadcast over the internet, utilizing aspects of the present invention.

### DETAILED DESCRIPTION OF THE PREFERRED EMBODIMENT

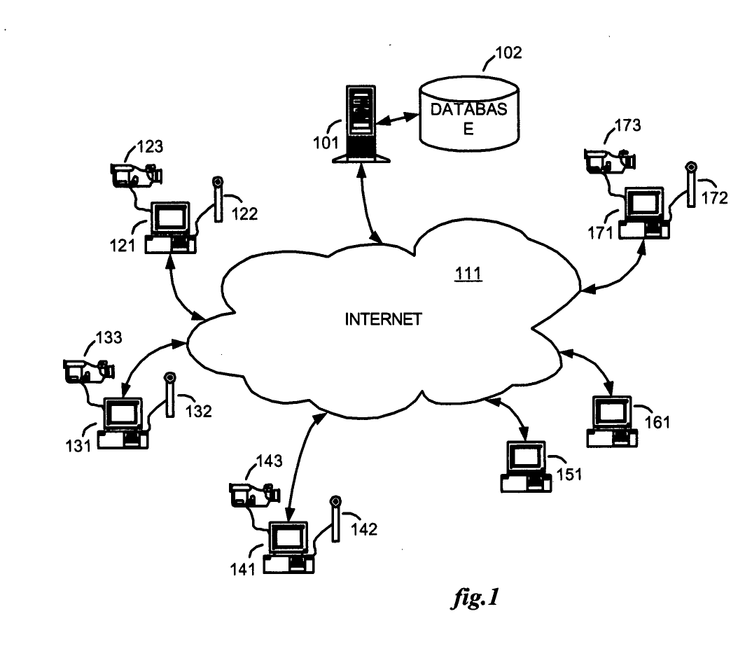

FIG. 1 illustrates, as an example, a network diagram of a system for broadcasting live personal performances over the Internet 111, that includes a Web Server 101 with an associated User Database 102, one or more Presenter Operated Computers, such as exemplified by personal computers 121, 131 and 141, and one or more Viewer Operated Computers, such as exemplified by personal computers 151, 161 and 171.

Operators of the Presenter Operated Computers are referred to as being “Presenters” and are generally individuals performing the live personal performances being broadcasted over the Internet. Operators of the Viewer Operated Computers, on the other hand, are referred to as being “Viewers” or “Attendees” and are generally individuals who view or otherwise attend sessions of the live personal performances being broadcasted over the Internet. The performances are referred to as being “live” if they are being broadcast to Viewers substantially at the time of the performance, taking into account typical transmission and buffering delays. The performances are also referred to as being “personal” if they are being performed by the Presenter. The performances may be presented to Viewers using audio and video (the preferred mode), or audio only, or video only, or slideshow or picture presentations with or without audio.

The Web Server 101 acts as a hub through which all data and other communications between the Presenter and Viewer Operated Computers pass. In particular, when broadcasting a live personal performance, the Web Server 101 receives audio and video data (also referred to herein as audio/video or A/V data) of the performance from one of the Presenter Operated Computers at the scheduled time, and relays the received audio and video data to Viewer Operated Computers that have indicated a desire to receive such data and are logged on at the time.

The Web Server 101 also provides an improved way for prospective Viewers to locate live personal and other performances to view by providing categorized Program Schedules on corresponding webpages hosted by the Web Server 101. To select a program or performance to view, the Viewer clicks on the program listing in its Program Schedule.

The program listing in this case is a hyperlink that either initiates transmission of the performance through streaming media to the Viewer's computer for playback using a media player, or schedules the Viewer to attend a live performance if it has not yet started. In this latter case, the Web Server 101 may send an email or instant messenger reminder to the Viewer using a registered address just before the live performance is scheduled to begin.

Although a single Web Server 101 is shown in this network example, it is to be appreciated that multiple servers may be connected in a scalable fashion to perform the functions of the Web Server 101 to accommodate increasing numbers of Presenters and Viewers concurrently using the system. In addition to load balancing, additional servers may also be used for conventional fail-safe purposes.

To conduct a live personal performance, each Presenter Operated Computer is equipped with a microphone and video camera for generating audio/video data for the live personal performance. For example, the personal computer 121 is equipped with microphone 122 for generating the audio data, and video camera 123 for generating the video data. Although shown as separate items, the microphone 122 may also be integrated in the video camera 123.

In addition to a microphone and video camera, each Presenter Operated Computer also includes a Presenter Program which is downloaded from the Web Server 101 to the Presenter Operated Computer. The Presenter Program preferably works with the web browser of the Presenter Operated Computer to display a Presenter Display Screen on the computer's monitor with various window areas and controls as described subsequently. Another important function of the Presenter Program is to process the audio/video data generated by the microphone and video camera into formatted packets suitable for transmission over the Internet and playback by conventional media players.

When a Viewer participates as a passive attendee while viewing a live personal or other performance, the Viewer's computer need not be equipped with a microphone or video camera. As examples, personal computers 151 and 161 do not have such equipment. If the Viewer and Presenter want to interact with each other in this case, a chat facility is provided through the Web Server 101 to communicate text messages back and forth between the two.

In some sessions, it may be desirable for the Presenter to see and hear the Viewer, in addition to the Viewer being able to see and hear the Presenter. For example, this may be desirable for some personal services such as one-on-one tutoring, consulting or fortune telling. It would also be desirable in certain group activities such as friendship or romance.

In this case, a Viewer Operated Computer may also be equipped with a microphone and video camera for generating audio/video data for transmission back to the Presenter. For example, the personal computer 171 is equipped with microphone 172 for generating the audio data, and video camera 173 for generating the video data.

In order to properly manage performance sessions as well as facilitate possible financial transactions between Presenters and Viewers, all Presenters and Viewers using the system are preferably registered with the Web Server 101 and their respective information stored in the User Database 102 in a secure fashion. The Sponsor owning and managing the Web Server 101 may either register the parties in such case for free, or charge them to register and participate, depending upon the business model being followed.

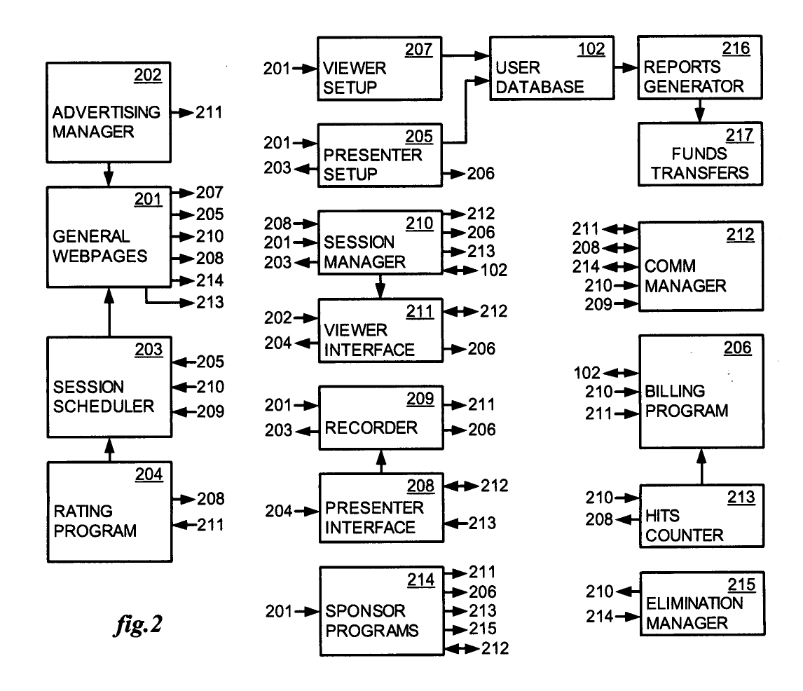

FIG. 2 illustrates, as an example, a block diagram of software modules used in a Website hosted on the Web Server 101 for managing performance sessions, broadcasting live personal and other performances over the Internet 111, and handling certain financial transactions related to the performance sessions. The Website in this case is owned and operated by an entity referred to herein as Sponsor. Although shown as separate modules, it is to be appreciated that some or all of these modules may be combined in practice with other of these modules for convenience or other good reasons while providing the functionality described herein.

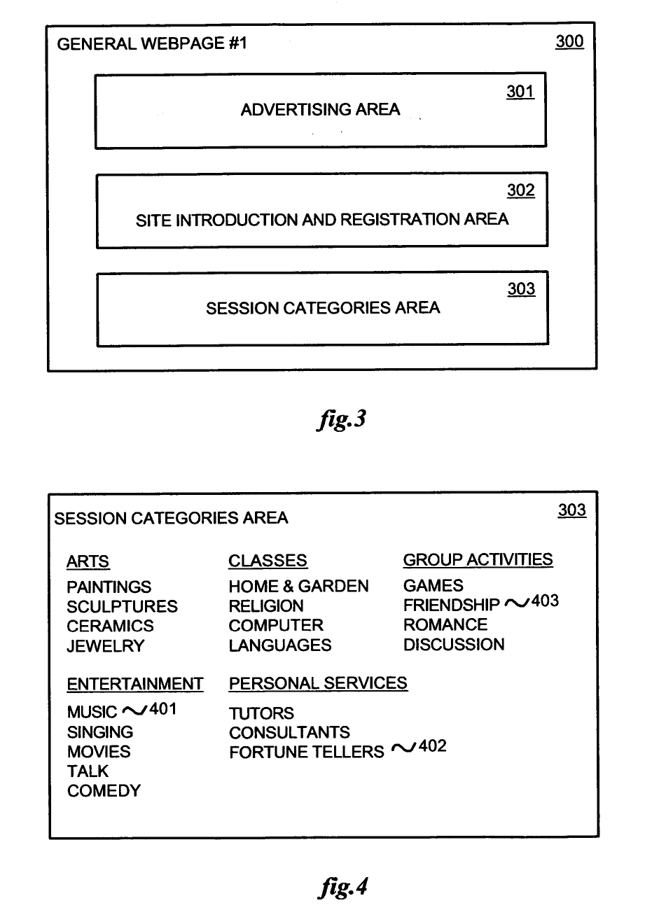

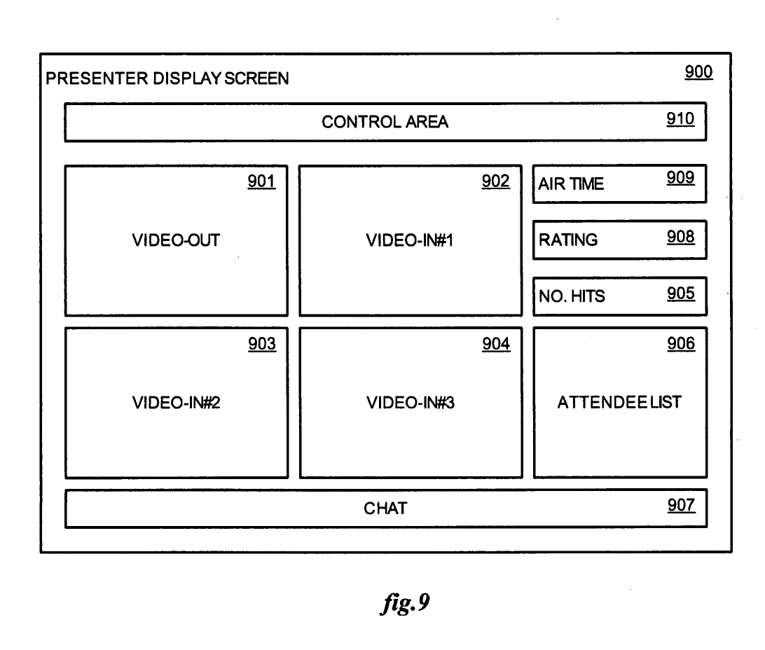

General Webpages 201 include a top-level webpage such as General Webpage 300 of FIG. 3, which is the first webpage viewed when accessing the Website hosted by the Web Server 101. The General Webpages 201 also include a hyperlinked tree of lower level webpages such as, for examples, second-level General Webpage 700 of FIG. 7, which is accessed through a hyperlink on the top-level General Webpage 300 to provide additional information on the hyperlinked item, and third-level General Webpage 800 of FIG. 8, which is accessed through a hyperlink on the second-level General Webpage 700 to provide additional information on the second-level hyperlinked item.

The first-level webpage preferably includes general information about the Website including hyperlinks to its various categories of presentations. Second-level webpages hyperlinked from the various categories of presentations include program schedules for the categories, and third-level webpages hyperlinked from the various presentations or sessions in the program schedules include additional information about the programs or Viewer reservation forms for scheduling attendance at limited audience presentations.

Presenter Setup module 205 is activated to query a Presenter for contact and other information to be stored in the User Database 102 when the Presenter first registers with the Website through the General Webpages 201. Typical contact information includes the Presenter's name, address, telephone number, and email address. Other information includes information about the performance or session to be conducted by the Presenter, information of any products or services to be sold in conjunction with the performance by the Presenter and their pricing, and financial information for the Presenter that is used for paying the Presenter any collected money for those products and services.

Viewer Setup module 207 is activated to query the Viewer for contact and other information to be stored in the User Database 102 when a new Viewer registers with the Website through the General Webpages 201. Typical contact information includes the Viewer's name, address, telephone number, and email address. Other information includes payment method information such as a credit card type, number and expiration date, if the Viewer plans to purchase any products or services through the Website.

Advertising Manager 202 manages advertising to be displayed on the General Webpages 201 and Viewer Display Screens. In order to display the advertising on the Viewer Display Screens, the Advertising Manager 202 goes through a Viewer Interface module 211.

Advertising displayed on the General Webpages 201 is a revenue source for the Sponsor of the Website. Advertising displayed on a Viewer Display Screen, however, may be a revenue source shared between the Sponsor and a Presenter whose presentation is being viewed at the time by a Viewer through a Viewer Display Screen. In this latter case, advertising banners to be displayed on Viewer Display Screens may be provided by either the Website or the Presenter. When provided by the Website, the Advertising Manager 202 may select advertising from its database of advertising banners that is particularly appropriate for a Viewer for display on the Viewer Display Screen. The advertisement selection in this case may be based upon the Viewer's demographic or geographic information stored in the User Database 102, and/or other information such as past purchase activity by the Viewer. When the advertising banner is provided by the Presenter, the Advertising Manager 202 provides that advertising banner to Viewer Display Screens playing the Presenter's presentation at that time.

Session Scheduler 203 generates the category program schedules provided on the General Webpages 201 from information received from various other modules. Information that is particular to a presentation such as a presentation title, description and broadcast time is provided by Presenters for their respective presentations through the Presenter Setup module 205 at the time that the Presenters register with the Website. Information of recorded presentations that are available at any for viewing is provided by a Recorder module 209 when such presentations are recorded or otherwise received. Information of presentations currently in progress is provided by a Session Manager 210 when the session is first initiated by the Presenter starting to transmit audio/video data for the presentation. Information of the Presenter or presentation Viewer ratings is provided by a Rating Program 204 on an on-going basis.

In addition to providing program schedules for the various presentation categories, the Session Scheduler 203 also schedules One-On-One and One-On-Few sessions for Presenters performing such sessions under, for example, a Personal Services major category section. As their names imply, One-On-One sessions involve one Presenter and one Viewer, and One-On-Few sessions involve one Presenter and a limited number of Viewers. Since the number of Viewers are limited in these types of sessions, attendance is based upon reservations before hand, typically on a Pay-Per-Session or Pay-Per-Time basis.

Session Manager 210 manages each presentation or session conducted through the Website. First of all, it controls access to the system by requiring all Presenters and Viewers to provide correct User Identifications and Passwords as confirmed by corresponding information stored in the User Database 102 during a conventional Log-On process.

A live presentation or session then begins when a Presenter initiates the presentation through a control area included on a Presenter Display Screen that is displayed on the monitor of the Presenter's computer. Conversely, the live presentation ends when the Presenter terminates the presentation through the same control area. As previously explained, the Presenter Display Screen is generated by a Presenter Program which has been downloaded from the Website at the time of registration by the Presenter. Control information generated from Presenter action in the control area of the Presenter Display Screen is received at the Website through a Presenter Interface 208 which preferably maintains a persistent connection with the Presenter Program during the live presentation.

When a Viewer selects a live presentation for viewing, the Session Manager 210 adds that Viewer to an attendee list, which is displayed in an area on the Presenter Display Screen, and notifies a Hits Counter 213 to increment a total hits count, which is displayed in another area on the Presenter Display Screen. The Session Manager 210 also notifies a Communication Manager 212 to establish a communication channel and start managing the flow of audio/video data for the live presentation from the Presenter Interface 208 to the Viewer Interface 211, as well as any other communications between the two interfaces.

In addition to managing live presentation sessions, the Session Manager 210 also manages sessions for Sponsor Programs 214. In these sessions, the session starts when a Viewer becomes the first in a session to select one of the Sponsor Programs 214. The selected Sponsor Program then effectively becomes the Presenter for session presentation and control purposes.

Each time a Viewer joins the session, the Session Manager 214 notifies the Communication Manager 212 to establish a communication channel and start managing the flow of data and communications between the selected Sponsor Program and that Viewer's computer through the Viewer Interface 211. The selected Sponsor Program then uploads an HTML document to the Viewer's computer using the channel established by the Communication Manager 212, so that the web browser of that Viewer's computer generates an appropriate Viewer Display Screen on its monitor. Meanwhile, the Session Manager 210 also notifies the Hits Counter 213 each time a Viewer joins the session to increment a total hits count for the session. The session then ends when either the selected Sponsor Program ends it, or the last Viewer exits it.

Commonly owned U.S. patent application Ser. No. 09/563,658 entitled “Method and Apparatus for Conducting an Interactive Design Conference over the Internet,” and commonly owned U.S. patent application Ser. No. 10/318,393 entitled “Method and Apparatus for Conducting a Collaboration Session in which Screen Displays are Commonly Shared with Participants,” provide additional details on systems using similar components such as the Session Manager 210 and Communication Manager 212 and are accordingly, both incorporated herein by reference.

Billing Program 206 determines and keeps track of revenue earned by the Sponsor and individual Presenters. Revenue may be earned in this system by the Sponsor through advertising managed by the Advertising Manager 202 as calculated using a hits count maintained by the Hits Counter 213, through charges for Viewers using Sponsor Programs 214, and through service charges or fees that are charged to Presenters. Typically, the service charges include a percentage of the revenue earned by individual Presenters.

Revenue may be earned in this system by individual Presenters through advertising provided by the Presenters and managed by the Advertising Manager 202 as calculated using a hits count maintained by the Hits Counter 213, and through product and service sales to Viewers. When a Viewer purchases a product from the Presenter in conjunction with a presentation over the Internet 111 such as a Pay-Per-Download or a product to be shipped, an indication of such product purchase is received by the Billing Program 206 from the Viewer Display Screen through the Viewer Interface 211. When a Presenter's presentation is charged as a service and performed on a Pay-Per-View, Pay-Per-Session or Pay-Per-Time basis, an indication of such service purchase and the time of the session if appropriate is received by the Billing Program 206 from the Session Manager 210.

The Billing Program 206 then retrieves pricing for the purchased product or service from the Presenter's profile in the User Database 102, calculates the appropriate charge, and tentatively charges the Viewer's account for the calculated amount. A confirmation of the purchase is then emailed to the Viewer by the Billing Program 206 according to contact information retrieved from the Viewer's profile in the User Database 102.

The Billing Program 206 then waits for an appropriate period of time before actually charging the Viewer for the product or service purchased. For example, if the Viewer does not contest the purchase within five days after confirmed receipt of a shipped product, or within two days after downloading a Pay-Per-Download product, or within six hours after a Pay-Per-View, Pay-Per-Session or Pay-Per-Hour session, then the Billing Program 206 retrieves the Viewer's payment method information from the Viewer's profile in the User Database 102, and charges the Viewer for the purchase according to the Viewer's payment method. At this time, the Presenter's account is also credited with the sale less Sponsor service charges and other expenses such as taxes. If the Viewer does contest the purchase within the indicated period of time, however, then the Presenter is notified of such, and the Viewer is not charged until the purchase is resolved between the Viewer and the Presenter.

Reports Generator 216 periodically generates reports of individual Presenter accounts, and sends those reports electronically or by mail to the Presenters according to contact information stored in their respective profiles in the User Database 102. The Reports Generator 216 also sends the account information to Funds Transfers module 217 so that it can generate checks to be sent to specified addresses of the Presenters, or wire transfer the funds to their specified bank accounts.

The Rating Program 204 receives ratings from Viewers of presentations that they are attending at the time or have just recently attended, and computes and provides averages of those ratings to the Session Scheduler 203 for inclusion along with their respective listings for future broadcasts by the same Presenter in the program schedules generated by the Session Scheduler 203. It also provides moving averages of ratings as such ratings are received during a presentation to its Presenter by sending the information to the Presenter's Display Screen through the Presenter Interface 208. Ratings for Sponsor Programs are also received from their Viewers and handled in a similar manner by the Rating Program 204 so that averages of those ratings are computed and provided to the Session Scheduler 203 for inclusion along with their respective Sponsor Program listings in the program schedules generated by the Session Scheduler 203.

The Elimination Manager 215 is a special module used in conjunction with certain of the Sponsor Programs 214 to eliminate Viewers from a session according to predefined rules.

The Recorder 209 is used to record presentations as requested by their respective Presenters so that those recordings can be made available for viewing at any time by Viewers. At the time of the recording, the Recorder 209 informs the Session Scheduler 203 of the availability of the recording so that it can be included in the program schedules generated by the Session Scheduler 203. When a Viewer subsequently selects the recording for viewing from the program schedules provided on the General Webpages 201, an indication of such is received by the Recorder 209 and the Recorder 209 initiates transmission of the recording through the Viewer Interface 211 to the Viewer's Display Screen. If the recording is a Pay-Per-View recording, the Recorder also sends the Viewer and recording information to the Billing Program 206 so that the Viewer can be properly charged for the viewing.

FIG. 3 illustrates, as an example, a top-level General Webpage 300, which is the first webpage viewed when accessing the web site hosted by the Web Server 101. An Advertising Area 301 displays a commercial advertisement preferably in the form of an advertising banner, which is managed by the Advertising Manager 202. A Site Introduction and Registration Area 302 introduces new users to the Website and registers them by interfacing with the Viewer Set-Up module 207 for new Viewers and the Presenter Set-Up module 205 for new Presenters. A Session Categories Area 303 displays various categories of performances offered for viewing on the Website.

FIG. 4 illustrates, as an example, additional details of the Session Categories Area 303 of the top-level General Webpage 300. In the example, there are five major category sections respectively titled Arts, Entertainment, Classes, Personal Services, and Group Activities.

The Arts major category section includes a number of related categories such as Paintings, Sculptures, Ceramics, and Jewelry, which each serve as a hyperlink to a second-level webpage providing a program schedule for the selected category. As examples of performances in this category section, Artists (Presenters) may show and talk about their paintings while Viewers interact with the Artists by asking them questions through chat facilities provided in their respective display screens. The Artists may even negotiate sales of their art during these performances.

The Entertainment major category section also includes a number of related categories such as Music, Singing, Movies, Talk, and Comedy, which each serve as a hyperlink to a second-level webpage providing a program schedule for the selected category. As examples of performances in this category section, Musicians (Presenters) may play and talk about their music while Viewers interact with the Musicians by asking them questions or make requests of them through chat facilities provided in their respective display screens. Musicians with reputations may charge Viewers to view these performances on a Pay-Per-View basis. Musicians, with or without such reputations, may also sell their music during these performances on a Pay-Per-Download basis or on Compact Disc with appropriate tax and shipping charges.

The Classes major category section includes a number of categories in which classes are offered such as Home & Garden, Religion, Computer, and Languages, which each serve as a hyperlink to a second-level webpage providing a program schedule for the selected category. As examples of performances in this category section, Instructors (Presenters) may present lectures on various subjects within these categories on a Free, Pay-Per-View, Donation, Subscription or other basis, while also selling products and/or services related to such categories during such performances.

The Personal Services major category section includes a number of categories in which services are offered such as Tutors, Consultants, and Fortune Tellers, which each serve as a hyperlink to a second-level webpage providing a program schedule for the selected category. As examples of performances in this category section, Fortune Tellers (Presenters) may present fortune telling sessions to one or a limited number of Viewers on a Pay-Per-Session or Pay-Per-Minute basis.

Consultants and other personal service providers may find it advantageous to perform free classes covering general discussions about a subject in the Classes major category section, and sell their consulting services under the Personal Services major category section on a Pay-Per-Session (i.e., Pay-Per-View) or Pay-Per-Hour basis for handling more detailed or particular questions and answers on a One-To-One or One-To-Few Viewers format.

The Group Activities major category section includes a number of categories in which groups of Viewers interact such as Games, Friendship, Romance, and Discussion, which each serve as a hyperlink to a second-level webpage providing a program schedule (including information of groups currently in session or just forming) for the selected category. Each of these categories is managed through a respective one of the Sponsor Programs 214 using a unique format particular to the category.

As an example, under the Discussion category, a limited number of Viewers may be admitted into an active discussion session with non-admitted Viewers being placed on a waiting list where they are able to view the on-going discussion, but not participate in it. Discussion in this case may be conducted through chat facilities in their respective Viewer display screens. To make the discussions more interesting than conventional chat rooms, video images of the participating Viewers may be displayed in the Viewer display screens, and periodically, one of the participating Viewers may be voted out of the discussion using the Elimination Manager 215.

As another example, a limited number of Viewers such as ten males and ten females may be admitted into an active Romance category session, wherein each of the Viewers participates in a five minute One-On-One session with each of the Viewers of the opposite sex, during which time, each participant secretly indicates whether he or she would like to get to further know the other participant. After all Viewers have thus had an opportunity to spend five minutes interacting with each Viewer of the opposite sex, Viewers that have chosen to get to know each other better (e.g., matches) are provided each other's contact information by the Sponsor Program managing the session. To enhance the experience, Viewer answers to compatibility questions are used by the Sponsor Program to select participants for each session, and each participating Viewer preferably uses a Viewer Operated Computer equipped with a microphone and video camera so that Viewers can talk and see each other during the five minute One-On-One sessions.

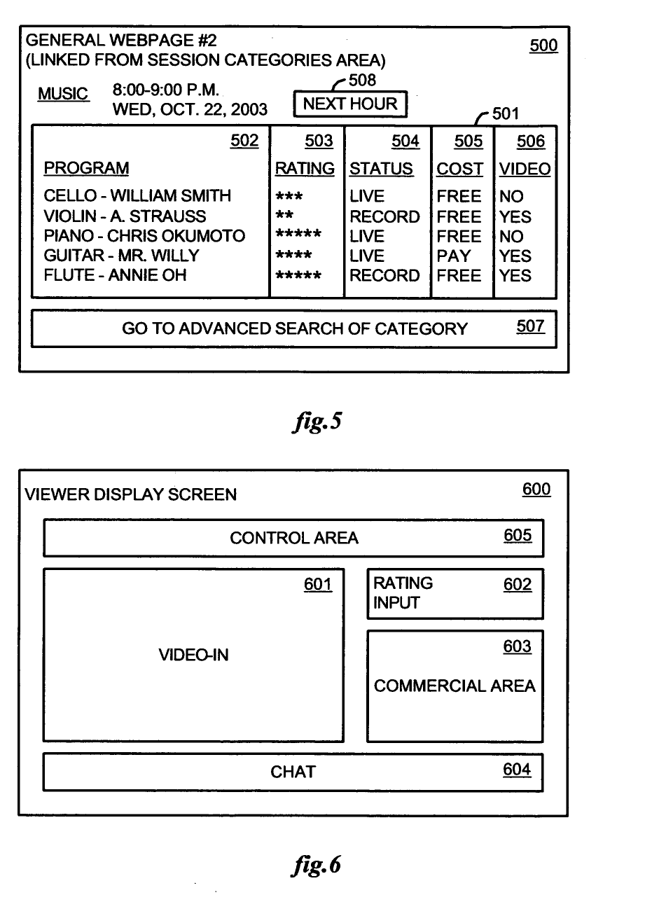

FIG. 5 illustrates, as an example, a second-level General Webpage 500 providing a Program Schedule 501 for a Music category. The second-level General Webpage 500 is displayed in this case after a prospective Viewer clicks on the hyperlink MUSIC 401 in the Session Categories Area 303 on the top-level General Webpage 300. In a program listing area 502, programs or presentations that are included in the music category and available for viewing at a given time and date are listed. The default time and date are always the current time and date. In a rating area 503, the average rating for each of the listed programs as computed by the Rating Program 204 is provided, if available, to assist prospective Viewers in their selection. In a status area 504, the status of the program as being a live presentation (LIVE) or a recording (RECORD) is shown. In a cost area 505, an indication of whether the program is free (FREE) or requires payment (PAY) is indicated. If a prospective Viewer then clicks on the hyperlink PAY for a presentation, the Viewer is provided a lower-level webpage providing information on the cost to view that presentation. In a video availability area 506, an indication of whether the presentation includes a video feed (YES) or only includes an audio feed (NO) is provided. In this example, it is assumed that all presentations will include at least an audio feed, but not all of them will include a video feed.

A search facility 507 is provided to make it easier for a prospective Viewer to find a presentation that he or she would like to view in the music category. The advanced search includes selectable criteria pertinent to the music category as well as desired viewing times, dates and a keyword area. If the Viewer desires to view all presentations available for viewing at the current time and date, however, he or she can simply scroll through them on the current page. A next hour button 508 is also provided to display program listings for a next hour, which the prospective Viewer can also scroll through.

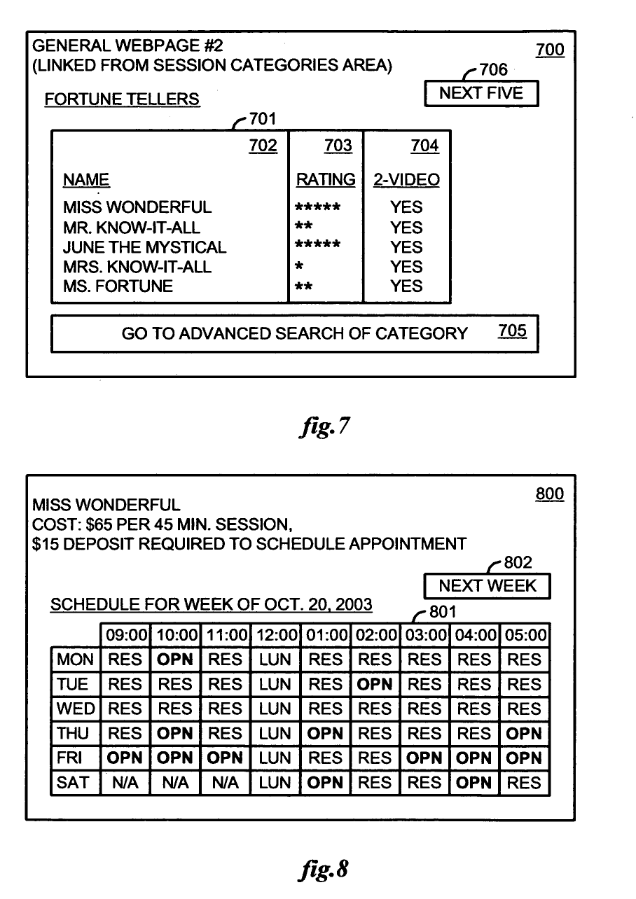

FIG. 6 illustrates, as an example, a Viewer Display Screen 600 displayed on a monitor of a Viewer Operated Computer by a web browser responding to an HTML document or JAVA applet downloaded from the Web Server 101. A video-in area 601 displays the video portion of audio/video data (i.e., the video feed) of a presentation that has been sent to the Viewer Operated Computer from the Web Server 101. A rating input area 602 provides a means for the Viewer to rate the presentation, such as selecting between one to five stars with one being the lowest and five being the highest. A commercial area 603 provides an area for advertising banners to be displayed, or where purchases of a product from the Presenter can be made. A chat area 604 provides a conventional chat facility for communicating text messages with the Presenter of a live presentation or session. A control area 605 provides an area where the Viewer can transmit certain control signals back to the Session Manager 210, such as terminating participation in the current session and ending the audio/video feed for the presentation.

FIG. 7 illustrates, as an example, a second-level General Webpage 700 providing a Program Schedule 701 for a Fortune Tellers category. The second-level General Webpage 700 is displayed in this case after a prospective Viewer clicks on the hyperlink FORTUNE TELLERS 402 in the Session Categories Area 303 on the top-level General Webpage 300. In a program listing area 702, programs that are included in the Fortune Tellers category and available for viewing at a given time and date are listed. The default time and date are always the current time and date. In a rating area 703, the average rating for each of the listed programs as computed by the Rating Program 204 is provided, if available, to assist prospective Viewers in their selection.

In a 2-video area 704, an indication of whether or not the fortune telling session allows the Presenter to also see and hear the Viewer is provided (YES or NO). In the example, it is assumed that the Viewer will always be able to see and hear the fortune telling Presenter. If it does, then the Viewer would have to be equipped with a microphone and video camera such as the Viewer Operated Computer 171 of FIG. 1, as well as a Special Viewer Program that will properly format the audio and video data to be suitable for transmission over the Internet 111 and playable in a media player invoked by the Presenter Program on the Present Operated Computer. If the fortune telling session does not allow the Presenter to also see and hear the Viewer, or the Viewer Operated Computer is not properly equipped for such transmission, then communications from the Viewer to the Presenter will be through the chat facility provided on the Viewer Display Screen.

A search facility 705 is provided to make it easier for a prospective Viewer to find a fortune telling session that he or she would like to view in the fortune tellers category. The advanced search includes selectable criteria pertinent to the fortune tellers category as well as desired times, dates and a keyword area. Otherwise, the Viewer can simply scroll through the listings.

FIG. 8 illustrates, as an example, a third-level General Webpage 800 providing a Reservation Schedule 801 for a fortune teller (Miss Wonderful) hyperlinked from the second-level General Webpage 700. The price that Miss Wonderful charges for a session is shown in the top left hand corner along with any deposit requirement for placing a reservation for a session with Miss Wonderful. The Reservation Schedule 801 in this case is organized in rows for each day of the week, and columns for each hour in the day. To check a Reservation Schedule for a next week, a NEXT WEEK button 802 is provided. If the day/time slot is already reserved by a Viewer, then it is indicated as being reserved by the letters RES. By clicking on the letters RES, the name of the Viewer reserving that day/time slot is displayed. On the other hand, if the day/time slot is available, then this condition is indicated by the letters OPN. By clicking on the letters OPN, the Viewer can reserve that day/time slot.

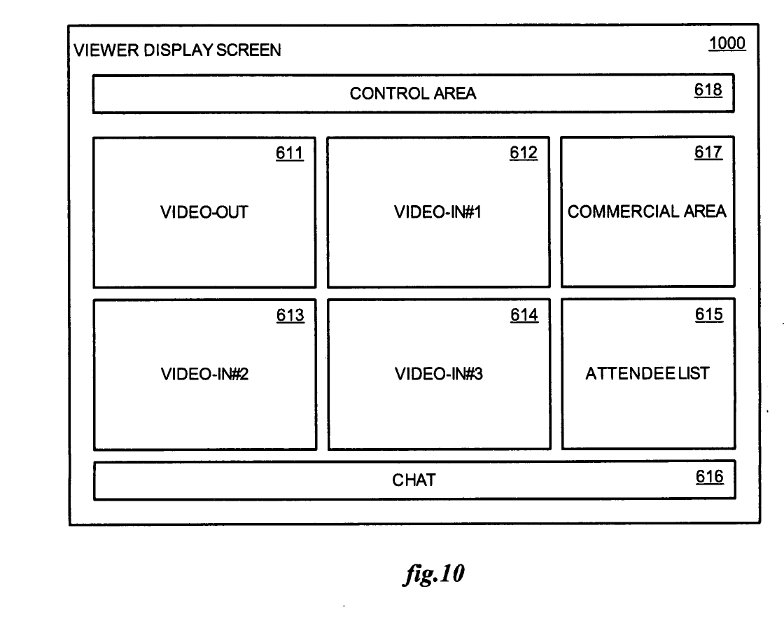

FIG. 9 illustrates, as an example, a Presenter Display Screen 900 that is displayed on a monitor of a Presenter Operated Computer by a Presenter Program that was downloaded from the Web Server 101 at the time the Presenter registered with the website. In this example, a video display area of the Presenter Display Screen 900 is divided up into four windows. A Video-Out window 901 displays the video output of the Presenter's video camera, which is video portion of the audio/video data of the Presenter's live personal performance that is being broadcast at the time over the Internet 111. Video-In windows 902, 903 and 904 respectively display the video portions of audio/video data received from three Viewers.

A number of hits area 905 displays the total number of viewers that have viewed at least a portion of the Presenter's presentation up to this time, even if they are no longer viewing it at the time. An Attendee List area 906 displays a list of all Viewers who are currently viewing the Presenter's live presentation. A chat area 907 provides a conventional chat facility for communicating text messages with Viewers. A rating area 908 provides an up-to-date Viewers rating of the current live personal performance as determined by the Rating Program 204. An air time area 909 indicates the current time, the length of time that the current session has been active, and the length of time that the current session still has before terminating.

A control area 910 provides an area where the Presenter can transmit certain control signals back to the Session Manager 210, such as immediate termination of the current performance, selecting the number of Video-Out windows to be displayed up to a predetermined number, selecting the Viewers in the attendee list 906 whose video data is to be received from the Web Server 101 and displayed in the Video-Out windows, and selecting the Viewer in the attendee list 906 whose audio data is to be received from the Web Server 101 and consequently, is to be heard on the Presenter's speakers. Note that if the Presenter chooses not to receive any video data from Viewers or if none is available for receiving, then the video display area of the Presenter Display Screen 900 would expand in size to take up the entire area shown as being used for the four windows 901˜904.

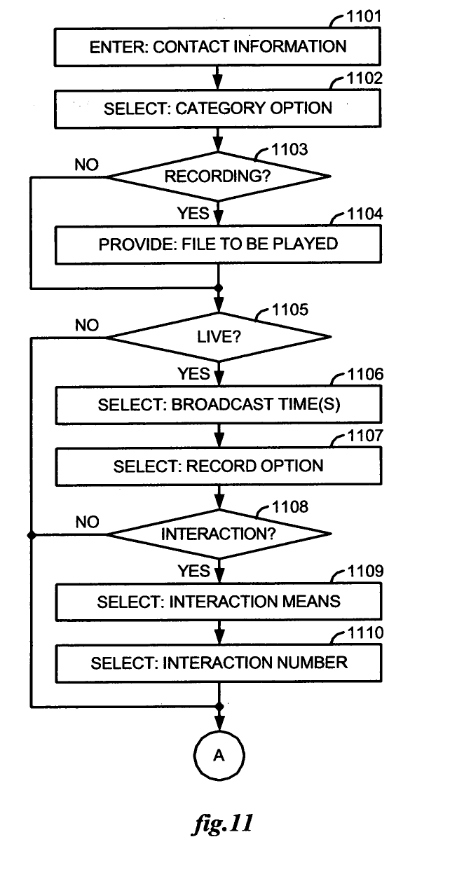

FIG. 10 illustrates an alternative Viewer Display Screen 1000 specially configured for a Discussion category which is one of the Sponsor Programs 214. Note that in this example, the Sponsor Program acts as the Presenter since all participants in the discussion are Viewers. The Viewer Display Screen 1000 is displayed on a monitor of a Viewer Operated Computer by its web browser responding to an HTML document or JAVA applet downloaded from the Sponsor Program on the Web Server 101.

A Video-Out window 611 displays the video output of the Viewer's video camera. This is the same video output that is being sent to other participants in the discussion, so the Viewer sees what other discussion participants are seeing. Video-In windows 612, 613 and 614 respectively display video data received from three other participants in the discussion. Typically, the Video-In windows show the faces of the discussion participants. The number of Video-In windows depends upon the number of discussion participants. In this example, it is assumed that there are four participants. With more or less participants, the number of Video-In windows will increase or decrease, and the size of the Video-In windows will change accordingly so that the size of the video display area including all of the Video windows remains approximately the same.

An Attendee List area 615 displays a list of all Viewers who are currently participating in the discussion. A chat area 616 provides a conventional chat facility for communicating text messages between participants. A commercial area 617 provides an area for advertising banners to be displayed.

A control area 618 provides an area where the Viewer can transmit certain control signals back to the Sponsor Program. Examples include a control signal indicating that the Viewer is voluntarily terminating his or her participation in the discussion, or an a control signal indicating that the Viewer is voting to eliminate one of the other participants from the discussion group, or a control signal indicating that the Viewer would like to speak to the other participants in the discussion group.

With regards to this last example, in order to make sure that only one person speaks at a time, one of the participants in the discussion group is designated the Pilot. Usually, this is the first Viewer to join the discussion session. This individual has the power to control who has the right to talk at the time. This power can be temporarily passed to another Viewer if the current Pilot desires. Consequently, the Pilot's control area 618 has three additional controls. The first is to indicate which of the attendees has the current right to speak. The second is to indicate which of the attendees the Pilot is passing the Pilot token to (i.e., the Viewer who is being given the powers of the Pilot). The third is to take back the Pilot token. If the original Pilot is voted out of the discussion group, then the Pilot token is passed to the second Viewer to have the joined the discussion group. Alternatively, the discussion group may vote to decide who the Pilot should be.

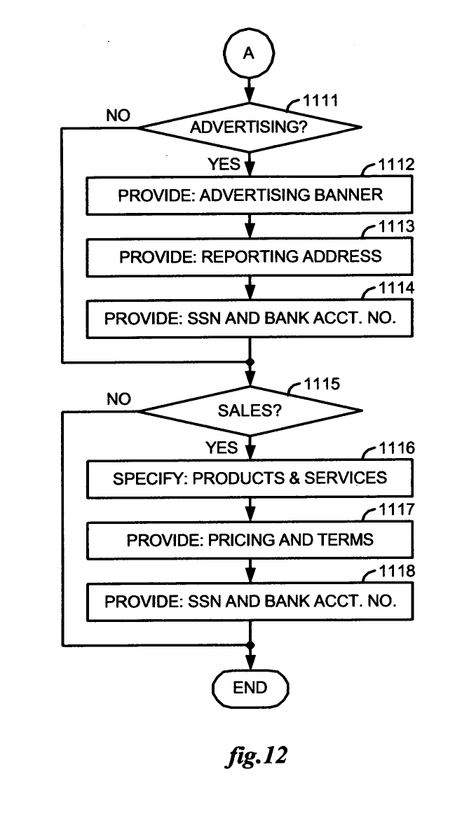

FIGS. 11-12 illustrate a flow diagram of a method performed by the Presenter Setup module 205 for registering and setting up a Presenter, and storing information received from the Presenter during the process in the Presenter's profile in the User Database 102. In 1101, contact information is requested from the Presenter, such as the Presenter's full name, business address, business phone number, business facsimile number, residence address, residence phone number, spouse's name, and email address. If money is to be collected on the Presenter's behalf for product and service sales, then additional contact information may be requested for the spouse and for personal and/or business references.

In 1102, the Presenter is asked to select a category for his or her presentation from a list of categories. In 1103, the Presenter is asked whether the presentation will be from a recording. If the answer is YES, then in 1104, the Presenter is asked to upload the file in which the recording is stored. On the other hand, if the answer is NO, then in 1105, the Presenter is next asked whether the presentation will be live. If this answer is NO, then the method jumps to 1111 to request business revenue related information.

If the presentation is to be live (i.e., the answer to 1105 is YES), then in 1106, the Presenter is asked to specify a broadcast date and time for the live presentation. If live presentations will be made on a periodic basis such as weekly or be-weekly, then the Presenter. If it is not to be interactive (i.e., the answer is NO in 1108), then the method jumps to 1111. On the other hand, if it is to be interactive (i.e., the answer is YES in 1108), then in 1109, the Presenter is asked to select the interaction means among given options such as the built-in chat facility and/or 2-way audio/video transmission. This latter option is commonly used, for example, by Presenters performing under the Personal Services category on a One-To-One or One-To-Few Viewer session basis. Then in 1110, the Presenter is asked for the maximum number of Viewers with whom interaction will be conducted, such as one for a One-To-One Viewer session or “X” for a One-To-X Viewer session.

In 1111, the Presenter is asked whether he or she is providing the advertisement that is to be displayed on the Viewer Display Screens viewing his or her performance. If the answer is NO, then the method jumps to 1115. If the answer is YES, however, in 1112, the Presenter is asked to upload the file in which the advertising banner is stored, or provide a link to it. In 1113, the Presenter is asked to provide the entity name and address to which invoices for such advertising are to be sent, and in 1114, the Presenter is asked for his or her tax payer identification number and bank account number.

In 1115, the Presenter is asked whether he or she will be selling products or services during, or in conjunction with, his or her performance(s). If the answer is NO, then the Presenter Setup function is ended. On the other hand, if the Presenter will be selling products and/or services (i.e., the answer is YES in 1115), then in 1116, the Presenter is asked to provide names for the products and/or services. Code numbers are then assigned for each of the products and services to be sold by the Presenter. In 1117, the Presenter is asked to provide pricing for each of the products and services to be sold, and the basis for such pricing. For example, product pricing for a presentation may be for a CD recording of the presentation to be shipped to the Viewer, or on a Pay-Per-Download basis. Service pricing, on the hand, may be on a Pay-Per-Session, Pay-Per-Hour or other basis. In 1118, the Presenter is asked for his or her tax payer identification number and bank account number, if it has not already been provided 1114. At this point, the Presenter Setup function is ended.

Although the various aspects of the present invention have been described with respect to a preferred embodiment, it will be understood that the invention is entitled to full protection within the full scope of the appended claims.

1. A method for broadcasting live personal performances over the Internet, comprising:
displaying a program schedule on a webpage of a website such that said program schedule includes a hyperlink to a broadcast of a live personal performance to be performed at a scheduled time over the Internet;
receiving audio and video data over the Internet for said live personal performance from a computer operated by a presenter logged on to said website and performing said live personal performance at approximately said scheduled time; and
broadcasting said received audio and said received video data to one or more computers respectively operated by viewers logged on to said website and having indicated a desire to receive such broadcast by clicking on said hyperlink.

2. The method according to claim 1, wherein said program schedule corresponds to a category of live personal performances, and said displaying said program schedule comprises clicking on a hyperlink corresponding to said category on a higher level webpage hosted by said website.

3. The method according to claim 2, wherein said higher level webpage includes hyperlinks for a plurality of categories organized by major category sections.

4. The method according to claim 2, wherein under one of said major category sections is a category including live personal performances performed over the Internet by musicians.

5. The method according to claim 2, wherein under one of said major category sections is a category including interactive personal performances performed over the Internet by fortune tellers.

6. The method according to claim 2, wherein said program schedule includes hyperlinks to a plurality of personal performances organized by broadcast times.

7. The method according to claim 2, wherein said program schedule includes hyperlinks to a plurality of personal performances and corresponding ratings determined by viewers of past performances of presenters presenting said plurality of personal performances.

8. The method according to claim 2, wherein said program schedule includes hyperlinks to a plurality of personal performances individually clickable by a prospective viewer to select individual of said plurality of personal performances for viewing over the Internet.

9. The method according to claim 1, wherein said webpage includes access to a search engine for identifying personal performances in said program schedule meeting specified criteria.

10. The method according to claim 1, further comprising uploading a presenter program to said computer operated by said presenter, and said receiving said audio and said video data includes receiving said audio and said video data from said computer in cooperation with said presenter program.

11. The method according to claim 10, wherein said presenter program causes a display screen of said computer operated by said presenter to display video corresponding to said video data in a video area, and a control area for controlling transmission of said audio and said video data from said computer operated by said presenter.

12. The method according to claim 1, wherein said broadcasting said audio and said video data further includes transmission of an HTML document so that web browsers on said one or more computers respectively operated by said viewers are responsive to said HTML document to display video in a video area driven by said video data.

13. The method according to claim 12, wherein said HTML document further causes said web browsers to display corresponding performance rating input areas for accepting ratings of performances being viewed at the time by said viewers.

14. The method according to claim 13, wherein information of said ratings of performances is included on said program schedule for corresponding performances included therein.

15. An apparatus for broadcasting live personal performances over the Internet, comprising a server configured to:
display a program schedule on a webpage of a website such that said program schedule includes a hyperlink to a broadcast of a live personal performance to be performed at a scheduled time over the Internet;
receive audio and video data for said live personal performance over the Internet from a computer operated by a presenter logged on to said website and performing said live personal performance at approximately said scheduled time; and
broadcast said received audio and said received video data to one or more computers respectively operated by viewers logged on to said website and indicating a desire to receive such broadcast by clicking on said hyperlink.

16. The apparatus according to claim 15, wherein said program schedule corresponds to a category of live personal performances, and said computer is further configured to display said program schedule when a hyperlink corresponding to said category on a higher level webpage hosted by said website is clicked by a viewer on a computer operated by said viewer.

17. The apparatus according to claim 16, wherein said higher level webpage includes hyperlinks for a plurality of categories organized by major category sections.

18. The apparatus according to claim 16, wherein under one of said major category sections is a category including live personal performances performed over the Internet by musicians.

19. The apparatus according to claim 16, wherein under another one of said major category sections is a category including interactive personal performances performed over the Internet by fortune tellers.

20. The apparatus according to claim 16, wherein said program schedule includes hyperlinks to a plurality of personal performances organized by broadcast times.

21. The apparatus according to claim 16, wherein said program schedule includes hyperlinks to a plurality of personal performances and corresponding ratings determined by viewers of past performances of presenters presenting said plurality of personal performances.

22. The apparatus according to claim 16, wherein said program schedule includes hyperlinks to a plurality of personal performances individually clickable by a prospective viewer to select individual of said plurality of personal performances for viewing over the Internet.

23. The apparatus according to claim 15, wherein said webpage includes access to a search engine for identifying personal performances in said program schedule meeting specified criteria.

24. The apparatus according to claim 15, wherein said server is further configured to upload a presenter program to said computer operated by said presenter, and receive said audio and said video data from said computer in cooperation with said presenter program.

25. The apparatus according to claim 24, wherein said presenter program causes a display screen of said computer operated by said presenter to display video corresponding to said video data in a video area, and a control area for controlling transmission of said audio and said video data by said presenter from said computer operated by said presenter.

26. The apparatus according to claim 15, wherein server is further configured to transmit an HTML document prior to broadcasting said audio and said video data so that web browsers on said one or more computers respectively operated by said viewers are responsive to said HTML document to display video in a video area driven by said video data.

27. The apparatus according to claim 26, wherein said HTML document further causes said web browsers to display corresponding performance rating input areas for accepting ratings of performances being viewed at the time by said viewers.

28. The apparatus according to claim 27, wherein information of said ratings of performances are included on said program schedule for corresponding performances included therein.

29. A method for broadcasting live personal performances over the Internet, comprising:
receiving audio/video data over the Internet of personal performances respectively from presenter operated computers according to a program schedule provided on a webpage; and
relaying individual of said received audio/video data over the Internet to one or more viewer operated computers as respectively requested by actions indicated through said webpage.

30. The method according to claim 29, wherein said personal performances are live personal performances.

31. The method according to claim 30, wherein said live personal performances are interactive personal performances.

32. The method according to claim 31, wherein one of said interactive personal performances is a session between a fortune teller operating one of said presenter operated computers and a customer operating one of said one or more viewer operated computers.

33. The method according to claim 31, wherein one of said interactive personal performances is a session between a tutor operating one of said presenter operated computers and a student operating one of said one or more viewer operated computers.

34. The method according to claim 29, wherein said relaying said individual of said received audio/video data is limited to relaying up to a prespecified number of said one or more viewer operated computers.

35. The method according to claim 34, further comprising receiving reservations from up to said prespecified number of said one or more viewer operated computers prior to said broadcasting.

36. The method according to claim 34, further comprising: facilitating payment for said relaying of said individual of said received audio/video data from viewers of said one or more viewer operated computers to presenters of said presenter operated computers having sent corresponding of said individual of said received audio/video data.

37. An apparatus for broadcasting live personal performances over the Internet, comprising a server configured to:
receive audio/video data over the Internet of live personal performances respectively from presenter operated computers according to a program schedule provided on a webpage hosted by said computer; and
relay individual of said received audio/video data over the Internet to one or more viewer operated computers as respectively requested by actions indicated through said webpage.

38. The apparatus according to claim 37, wherein said personal performances are live personal performances.

39. The apparatus according to claim 38, wherein said live personal performances are interactive personal performances.

40. The apparatus according to claim 39, wherein one of said interactive personal performances is a session between a fortune teller operating one of said presenter operated computers and a customer operating one of said one or more viewer operated computers.

41. The apparatus according to claim 39, wherein one of said interactive personal performances is a session between a tutor operating one of said presenter operated computers and a student operating one of said one or more viewer operated computers.

42. The apparatus according to claim 37, wherein said server is further configured to broadcast said individual of said received audio/video data to no more than a prespecified number of said one or more viewer operated computers.

43. The apparatus according to claim 42, wherein said server is further configured to receive reservations from up to said prespecified number of said one or more viewer operated computers prior to said broadcast.

44. The apparatus according to claim 42, wherein said server is further configured to facilitate payment for said relay of said individual of said received audio/video data from viewers of said one or more viewer operated computers to presenters of said presenter operated computers having sent corresponding of said individual of said received audio/video data.

45. A system for broadcasting live personal performances over the Internet, comprising:
a plurality of presenter operated computers;
a plurality of viewer operated computers; and
a web server hosting a webpage providing a program schedule, receiving audio and video data over the Internet of live personal performances respectively from said plurality of presenter operated computers at times according to said program schedule, and broadcasting individual of said received audio and video data over the Internet respectively to individual of said plurality of viewer operated computers as requested by actions indicated by their respective users through said webpage.

46. The system according to claim 45, wherein individual of said plurality of presenter operated computers are equipped with a microphone, video camera, and a presenter program so that said microphone generates said audio data, said video camera generates said video data, and said presenter program formats said audio and said video data into packets suitable for transmission over the Internet and playback in media players of said individual of said plurality of viewer operated computers.

47. The system according to claim 46, wherein said presenter program is uploaded to said individual of said plurality of presenter operated computers from said web server.

48. The system according to claim 45, wherein said web server includes a session manager that manages live personal performance sessions involving presenters operating individual of said plurality of presenter operated computers to perform live personal performances and attendees operating individual of said plurality of viewer operated computers so as to view individual of said live personal performances.

49. The system according to claim 48, wherein said web server further includes a session scheduler for scheduling sessions of live personal performances involving presenters operating individual of said plurality of presenter operated computers and attendees operating individual of said plurality of viewer operated computers to view said live personal performances.

50. The system according to claim 49, wherein said session scheduler generates said program schedule provided through said webpage.

51. The system according to claim 50, wherein said session scheduler schedules sessions for a limited number of attendees for individual of said live personal performances in which participation is limited.

52. The system according to claim 48, wherein said web server further includes a communications manager for managing communications between individual of said presenters and individual of said viewers in said live personal performance sessions.

53. The system according to claim 48, wherein said web server further includes a billing program facilitating payment for goods and services to presenters of said live personal performances by viewers of said live personal performances purchasing such goods and services.

54. The system according to claim 53, wherein said viewers of said live personal performances are registered users in a database associated with said web server.

55. The system according to claim 48, wherein said web server further includes a rating program providing information of viewer ratings of said live personal performances to said session scheduler for inclusion in said program schedule.

56. The system according to claim 48, wherein said web server uploads an HTML document to said individual of said plurality of viewer operated computers so as to cause said audio and said video data broadcasted to said individual of said plurality of viewer operated computers to be played by a media player in a web browser of said individual of said plurality of viewer operated computers.

57. A method for broadcasting audio/video data over the Internet, comprising:
generating a program schedule organized by categories and broadcast times from information received over the Internet from a plurality of presenter operated computers;
providing said program schedule on a webpage;
receiving audio/video data over the Internet from said plurality of presenter operated computers; and
broadcasting at their respective broadcast times over the Internet, individual of said received audio/video data to one or more viewer operated computers as requested by their users over the Internet through said webpage.

58. The method according to claim 57, further comprising: setting up an account for a presenter of a live personal performance by storing contact information, a tax identification number, and a bank account number for the presenter in a user database.

59. The method according to claim 58, wherein said setting up said account for said presenter includes storing pricing information for products and services offered for sale by said presenter in said user database.

60. The method according to claim 58, wherein said setting up said account for said presenter includes storing a reporting address for an advertising banner displayed on individual of said one or more viewer operated computers receiving the broadcast of the live personal performance of said presenter.

61. The method according to claim 60, further comprising: counting the number of hits for said advertising banner, and calculating a royalty due to said presenter from an advertiser of said advertising banner according to said counted number of hits.

62. The method according to claim 57, further comprising: receiving an indication of a viewer interaction option from individual of said plurality of presenter operated computers, and including information of said indication in said program schedule.

63. The method according to claim 62, further comprising: receiving a specification of a maximum number of viewers to which audio/video data received from one of said presenter operated computers is to be broadcasted to, and including information of said maximum number in said program schedule.

64. An apparatus for broadcasting audio/video data over the Internet, comprising a web server configured to:
generate a program schedule organized by categories and broadcast times from information received over the Internet from a plurality of presenter operated computers;
provide said program schedule on a webpage;
receive audio/video data over the Internet from said plurality of presenter operated computers; and
broadcast at their respective broadcast times over the Internet, individual of said received audio/video data to one or more viewer operated computers as requested by their users over the Internet through said webpage.

65. The apparatus according to claim 64, wherein said web server is further configured to set up an account for a presenter of a live personal performance by receiving contact information, a tax identification number, and a bank account number from said presenter and storing such in a user database.

66. The apparatus according to claim 65, wherein said web server is further configured to set up said account by receiving pricing information for products and services offered for sale from said presenter and storing such in said user database.

67. The apparatus according to claim 65, wherein said web server is further configured to set up said account by receiving a reporting address for an advertising banner displayed on individual of said one or more viewer operated computers receiving the broadcast of the live personal performance of said presenter, and storing such address in said user database.

68. The apparatus according to claim 67, wherein said web server is further configured to determine a number of hits for said advertising banner, and report such information in order to calculate a royalty due to said presenter from an advertiser of said advertising banner for said number of bits.

69. The apparatus according to claim 64, wherein said web server is further configured to receive an indication of a viewer interaction option from individual of said plurality of presenter operated computers, and include information of said indication in said program schedule.

70. The apparatus according to claim 69, wherein said web server is further configured to receive a specification of a maximum number of viewers to which audio/video data received from one of said presenter operated computers is to be broadcasted to, and include information of said maximum number in said program schedule.

71. A method for transmitting audio/video data over the Internet, comprising:
transmitting a presenter program over the Internet to a presenter operated computer;
receiving audio/video data over the Internet from said presenter program running on said presenter operated computer; and
transmitting an HTML document and said received audio/video data to a viewer operated computer so that a web browser plays said received audio/video data in a window of a display screen of said viewer operated computer according to instructions in said HTML document.

72. The method according to claim 71, wherein said presenter program causes a presenter display screen including a video-out window and a control area to be displayed on a monitor of said presenter operated computer so that said video portion of said audio/video data is shown in said video-out window while being transmitted over the Internet according to settings in said control area.

73. The method according to claim 72, wherein said presenter display screen further includes a video-in window so that a video portion of audio/video data received from said viewer operated computer is shown in said video-in window while an audio portion of said audio/video data received from said viewer operated computer is heard on a speaker of said presenter operated computer.

74. The method according to claim 72, wherein said HTML document and said audio/video data received from said presenter operated computer are transmitted to a plurality of viewer operated computers, and said presenter display screen further includes a plurality of video-in windows so that selected ones of video portions of audio/video data received from said plurality of viewer operated computers are shown in said plurality of video-in windows while a selected one of audio portions of said audio/video data received from said plurality of viewer operated computers is heard on a speaker of said presenter operated computer.

75. The method according to claim 74, wherein said presenter display screen further includes an attendee list identifying users of said plurality of viewer operated computers.

76. The method according to claim 74, wherein said presenter display screen further includes an area for showing a number of hits indicating the number of said plurality of viewer operated computers to which said HTML document has been transmitted.

77. The method according to claim 74, wherein said presenter display screen further includes an area for showing an average rating indicating the average of all ratings provided from said plurality of viewer operated computers for said audio/video data transmitted by said presenter operated computer.

78. The method according to claim 74, wherein said presenter display screen further includes a chat area for receiving text messages from said plurality of viewer operated computers.

79. The method according to claim 71, wherein said HTML document causes an attendee display screen including a video-in window to be displayed on a monitor of said viewer operated computer so that a video portion of said audio/video data is shown in said video-in window while an audio portion of said audio/video data is heard on a speaker of said viewer operated computer.

80. The method according to claim 79, wherein said attendee display screen further includes an area for inputting a rating for said audio/video data.

81. The method according to claim 79, wherein said attendee display screen further includes a chat area for inputting a text message to be sent to said presenter operated computer.

82. An apparatus for transmitting audio/video data over the Internet, comprising a web server configured to:
transmit a presenter program over the Internet to a presenter operated computer;
receive audio/video data over the Internet from said presenter program running on said presenter operated computer; and
transmit an HTML document and said received audio/video data to a viewer operated computer so that a web browser plays said received audio/video data in a window of a display screen of said viewer operated computer according to instructions in said HTML document.

83. The apparatus according to claim 82, wherein said presenter program causes a presenter display screen including a video-out window and a control area to be displayed on a monitor of said presenter operated computer so that said video portion of said audio/video data is shown in said video-out window while being transmitted over the Internet according to settings in said control area.

84. The apparatus according to claim 83, wherein said presenter display screen further includes a video-in window so that a video portion of audio/video data received from said viewer operated computer is shown in said video-in window while an audio portion of said audio/video data received from said viewer operated computer is heard on a speaker of said presenter operated computer.

85. The apparatus according to claim 83, wherein said HTML document and said audio/video data received from said presenter operated computer are transmitted to a plurality of viewer operated computers, and said presenter display screen further includes a plurality of video-in windows so that selected ones of video portions of audio/video data received from said plurality of viewer operated computers are shown in said plurality of video-in windows while a selected one of audio portions of said audio/video data received from said plurality of viewer operated computers is heard on a speaker of said presenter operated computer.

86. The apparatus according to claim 85, wherein said presenter display screen further includes an attendee list identifying users of said plurality of viewer operated computers.

87. The apparatus according to claim 85, wherein said presenter display screen further includes an area for showing a number of hits indicating the number of said plurality of viewer operated computers to which said HTML document has been transmitted.

88. The apparatus according to claim 85, wherein said presenter display screen further includes an area for showing an average rating indicating the average of all ratings provided from said plurality of viewer operated computers for said audio/video data transmitted by said presenter operated computer.

89. The apparatus according to claim 85, wherein said presenter display screen further includes a chat area for receiving text messages from said plurality of viewer operated computers.

90. The apparatus according to claim 82, wherein said HTML document causes an attendee display screen including a video-in window to be displayed on a monitor of said viewer operated computer so that a video portion of said audio/video data is shown in said video-in window while an audio portion of said audio/video data is heard on a speaker of said viewer operated computer.

91. The apparatus according to claim 90, wherein said attendee display screen further includes an area for inputting a rating for said audio/video data.

92. The apparatus according to claim 90, wherein said attendee display screen further includes a chat area for inputting a text message to be sent to said presenter operated computer.

93. A business method for broadcasting live personal performances over the Internet, comprising:
registering an attendee after receiving contact and payment method information from said attendee over the Internet;
providing a program schedule of live personal performances selectable for viewing over the Internet by said attendee;
charging said attendee according to said payment method information for goods and services purchased over the Internet in conjunction with a live personal performance selected for viewing by said attendee from said program schedule; and
paying a presenter of said live performance for said purchased goods and services less a service charge and expenses unless said attendee contests such paying within a period of time.

94. The method according to claim 93, wherein said registering said attendee includes associating said attendee with a unique user name and password.

95. The method according to claim 93, wherein said payment method information includes a credit card type and number.

96. The method according to claim 95, wherein said charging said attendee includes charging said credit card for said goods and said services purchased by said attendee after said period of time has elapsed provided said attendee does not contest said charging within said period of time for cause.

97. The method according to claim 93, further comprising registering said presenter before paying said presenter for said goods and said services purchased by said attendee.

98. The method according to claim 97, wherein said registering said presenter includes receiving contact information, pricing information for said goods and said services, and a tax payer identification number and a bank account number for said presenter.

99. The method according to claim 98, wherein said paying said presenter includes accumulating uncontested and due payments on a periodic basis for all purchases of said goods and said services provided by said presenter, generating a report of such purchases, sending said report to said presenter according to said contact information, and transferring said accumulated payment to said bank account number less said service charge and said expenses for each such purchase.

100. The method according to claim 93, further comprising:
providing an advertisement along with said program schedule;
counting the number of times that said program schedule is provided; and
invoicing an advertiser for an amount calculated using said counted number of times.

101. An apparatus for billing an attendee for goods and services purchased in conjunction with a live personal performance viewed over the Internet by the attendee, and pay the presenter of that live personal performance for those goods and services purchased by the attendee, comprising a computer configured to:
register an attendee after receiving contact and payment method information from said attendee over the Internet;
provide a program schedule of live personal performances selectable for viewing over the Internet by said attendee;
charge said attendee according to said payment method information for goods and services purchased over the Internet in conjunction with a live personal performance selected for viewing by said attendee; and
pay a presenter of said live performance for said goods and services less a service charge and expenses unless said attendee contests such payment within a period of time.

102. The apparatus according to claim 101, wherein said computer is configured to register said attendee by also associating said attendee with a unique user name and password.

103. The apparatus according to claim 101, wherein said payment method information includes a credit card type and number.

104. The apparatus according to claim 103, wherein said computer is configured to charge said attendee by charging said credit card number for said goods and said services purchased by said attendee after said period of time has elapsed provided said attendee does not contest said charging within said period of time for cause.

105. The apparatus according to claim 101, wherein said computer is further configured to register said presenter before paying said presenter for said goods and said services purchased by said attendee.

106. The apparatus according to claim 105, wherein said computer is configured to register said presenter by receiving contact information, pricing information for said goods and said services, and a tax payer identification number and a bank account number from said presenter.

107. The apparatus according to claim 106, wherein said computer is configured to pay said presenter by accumulating uncontested and due payments on a periodic basis for all purchases of said goods and said services provided by said presenter, generating a report of such purchases, sending said report to said presenter according to said contact information, and transferring said accumulated payment to said bank account number less said service charge and expenses for each such purchase.

108. The apparatus according to claim 101, wherein said computer is further configured to:
provide an advertisement along with said program schedule;
count the number of times that said program schedule is provided; and
invoice an advertiser for an amount calculated using said counted number of times.
